(19) United States
(12) Patent Application Publication
(10) Pub. No.: US 2011/0179990 A1
(43) Pub. Date: Jul. 28, 2011

(54) MONITORING UNIT FOR A MEASURING INSTRUMENT

(75) Inventor: Remzi Zecirovic, Berlin (DE)

(73) Assignee: Bundesanstalt fur Materialforschung und-prufung (BAM), Berlin (DE)

(21) Appl. No.: 12/305,930

(22) PCT Filed: Jun. 21, 2007
(86) PCT No.: PCT/EP2007/005496

§ 371 Date: Mar. 25, 2009

(30) Foreign Application Priority Data
Jun. 21, 2006 (DE) 10 2006 028 523.9

(51) Int. Cl. G01D 11/28

(52) U.S. Cl. 116/288

(57) ABSTRACT

A monitoring unit for a measuring instrument (100) with a pointer (120) and a face (110), pointer (120) and face (110) having mutually differing reflection behaviors for light, comprising at least one first detecting means (210) with a light source (220) and a sensor (230), and at least one fastening means (250) for fastening the detecting means (210) on the measuring instrument (100), it being possible to arrange the detecting means (210) with the aid of the fastening means (250) such that the first sensor (230) can pick up light (228) reflected by the measuring instrument (100) that was emitted by the first light source (220).

The present invention relates to a monitoring unit for a measuring instrument, in particular a monitoring unit for a measuring instrument with a pointer that moves in front of a face. In particular, the invention relates to a monitoring unit for a manometer.

Measuring instruments are known in the prior art that have either a digital display, for example an LED display, or an analogue display for the measured values determined. Such an analogue display typically has a pointer that can be moved relative to a scale of measurement values that is arranged on a dial plate. The pointer position is set in this case in accordance with the actual value of a variable such that the actual value of the variable can be read off on the scale of measurement values. In this case, the pointer and the face typically exhibit a different reflection behavior with reference to visible light such that the movement of the pointer in front of the background of the face can be detected by the human eye.

Measuring instruments frequently serve the purpose of monitoring process parameters for the purpose of ensuring a reliable process management. Thus, for example, manometers can be used for pressure monitoring in order to ensure the protection of the pressure conducting systems against overloading, as well as to ensure the control of the input pressure of pressure converting machines. For example, in case of life cycle tests on gas bottle valves (360 bar), it is necessary to protect the pressure maintaining system against an uncontrolled pressure rise by means of an upstream compressor (maximum 1600 bar), and at the same time to make sure the pressure is maintained in the system. Contact manometers are known for this task. Contact manometers are pressure measuring units which in addition to a continuous pressure display, are used chiefly to monitor and signal minimum and maximum pressures. In this case, a switching operation is performed as soon as the measured value pointer assumes a specific position relative to a settable desired value pointer. Different designs of contact manometers are known. If, for example, the pressure in a compressed gas bottle drops below a preset value, an inductive contact is switched, for example. Respective limiting signal transmitters can be set over the entire scale range, as required, for example, in DIN 16 085: Überdruckmessgeräte mit Einrichtungen zur elektrischen Grenzsignalabgabe [Overpressure measuring instruments with devices for electrical limiting signal transmission].

Contact manometers of the above described type are disclosed, for example, in DE 20 2004 004 377 U1, DE 31 05 495 A1, DE 23 32 249 A1, DE 27 15 753 A1 and DE 25 15 116 A1. A common feature of all the above named publications is that they make use of a so called forked light barrier. In the case of such a forked light barrier, a light source and a light sensor are situated opposite one another such that the light emitted by the light source strikes the sensor directly. If the pointer of the measuring instrument is now moved between the light source and the sensor, this leads to an interruption of the light barrier, and a corresponding signal pulse is triggered. However, the use of such a monitoring unit with a forked light barrier still requires the manometer to be modified, since the light barrier must be arranged such that the pointer can move through between light source and sensor. This is complicated, in particular, because pointer and dial plate are normally covered by a glass pane. For these reasons, the installation of such a monitoring unit is time consuming and can be undone again only with difficulty.

With regard to the above named disadvantages of the prior art, the present invention proposes a monitoring unit as claimed in claim 1. Further aspects, advantages and details of the present invention follow from the subclaims, the description and the attached drawings.

In accordance with a first exemplary embodiment of the present invention, a monitoring unit for a measuring instrument that has a pointer and a face is provided. In this case, the pointer and the face exhibit mutually differing reflection behaviors for light. For example, the face is colored white, whereas the pointer is colored black. However, this is to be understood merely as example: the present invention also has other colorings or differences in the reflection behavior based on different materials for pointer and face or different coatings of the same. The monitoring unit further comprises a first detecting means that has a light source and a sensor. The monitoring unit also comprises at least one fastening means that serves to fasten the detecting means on the measuring instrument. It is possible with the aid of the fastening means to arrange the detecting means such that the first sensor can pick up light reflected by the measuring instrument that has been emitted by the first light source.

By contrast with the above described contact manometers in accordance with the prior art, the monitoring unit in accordance with the exemplary embodiment of the present invention does not record an interruption of a light barrier, but a change in the reflecting behavior of the emitted light, that is to say a change in the characteristic of the reflected fraction of the emitted light. It is therefore no longer necessary to arrange light source and sensor opposite one another such that the pointer can move through between them. Rather, the light source and the sensor can, for example, be arranged laterally next to one another in accordance with a further exemplary embodiment, for example. Light source and sensor can therefore be fastened on a glass cover of the monitoring unit, for example, without the need to modify the monitoring unit. A further advantage of the inventive monitoring unit consists in that there is now no need to provide each measuring instrument with a respective monitoring unit if a single monitoring unit can serve successively to monitor various measuring instruments because of the ease with which the monitoring unit can be fitted on and removed from the measuring instrument. In the simplest and most cost effective case, the light source and the sensor can be fastened and positioned on the housing of the display unit with the aid of adhesive strips, for example. Simple wires can be used to supply electricity and for leading the respective signals in and out. The actual signal processing takes place in this case in an external unit.

In accordance with a further exemplary embodiment of the present invention, the detecting means comprises a lens for focusing the light emitted by the light source. In accordance with yet a further exemplary embodiment of the present invention, this lens be designed as a common lens for the light source and the sensor. Both the emitted, and also the reflected light is focused in this way by the same lens.

In accordance with another exemplary embodiment of the present invention, the light source is designed as a photodiode, in particular as an IR photodiode.

In accordance with yet another exemplary embodiment of the present invention, the sensor is designed as a phototransistor.

In accordance with a further exemplary embodiment of the present invention, the light source and the sensor are integrated in a housing.

In accordance with yet a further exemplary embodiment of the present invention, the monitoring unit is designed such that it is capable when operating of detecting the position of a pointer tip of the pointer.

In accordance with another exemplary embodiment of the present invention, the monitoring unit is designed such that it is capable when operating of detecting the position of a pointer foot of the pointer.

In accordance with yet another exemplary embodiment of the present invention, the fastening means is designed to be capable of fastening on a housing of the measuring instrument. For example, the fastening means can include a ring that, for example, can be fastened on the housing of the measuring instrument via screws. In accordance with a further exemplary embodiment of the present invention, this ring can be designed such that a number of detecting means can be fastened on it.

In accordance with another exemplary embodiment of the present invention, the fastening means can comprise a snap lock that permits the monitoring unit to be fastened on the housing of the measuring instrument quickly and easily.

In accordance with another exemplary embodiment of the present invention, the fastening means can be formed at least partially from a transparent material such as Perspex. In this way, for example, regions of the scale of measurement values, or else the pointer remain visible, for example, although they are located underneath the fastening means.

In accordance with another exemplary embodiment of the present invention, the detecting means is designed in a fashion integrated with the fastening means.

In accordance with another exemplary embodiment of the present invention, the monitoring unit further comprises a circuit. This circuit can be designed for driving the detecting means and/or for signal processing of signals from the detecting means, and for evaluating signals from the detecting means. In this way, signal conditioning and evaluation takes place as early as in the monitoring unit. In accordance with one exemplary embodiment of the present invention, the circuit is designed in a fashion integrated with the fastening means. For example, it can be encapsulated together with the detecting means with the aid of two-component casting resin, in order to enable explosion-protected operation. Furthermore, the responsiveness of the circuit can be designed to be capable of being set so that the circuit can be adapted to various measuring instruments.

In accordance with yet a further exemplary embodiment of the present invention, the monitoring unit can include a further detecting means. It is possible in this way either to achieve a redundancy in the measurement of the pointer position, or else to define maximum and minimum values of a measuring means. In one embodiment, the spacing between the first and the second detecting means is variable so that a measuring range can be variably prescribed. According to another embodiment the spacing between the first and the second detecting means is permanently prescribed. It is possible in this way to prescribe precisely an exact measuring range for a specific type of measuring instrument.

In accordance with one exemplary embodiment of the present invention, the measuring instrument is a manometer. In this case, the monitoring unit can be connected to a pressure controller via external connection.

Exemplary embodiments of the present invention will now be explained with the aid of the attached drawings, in which:

FIG. 1 shows a plan view of a measuring instrument with a schematic illustration of a monitoring unit in accordance with one exemplary embodiment of the present invention;

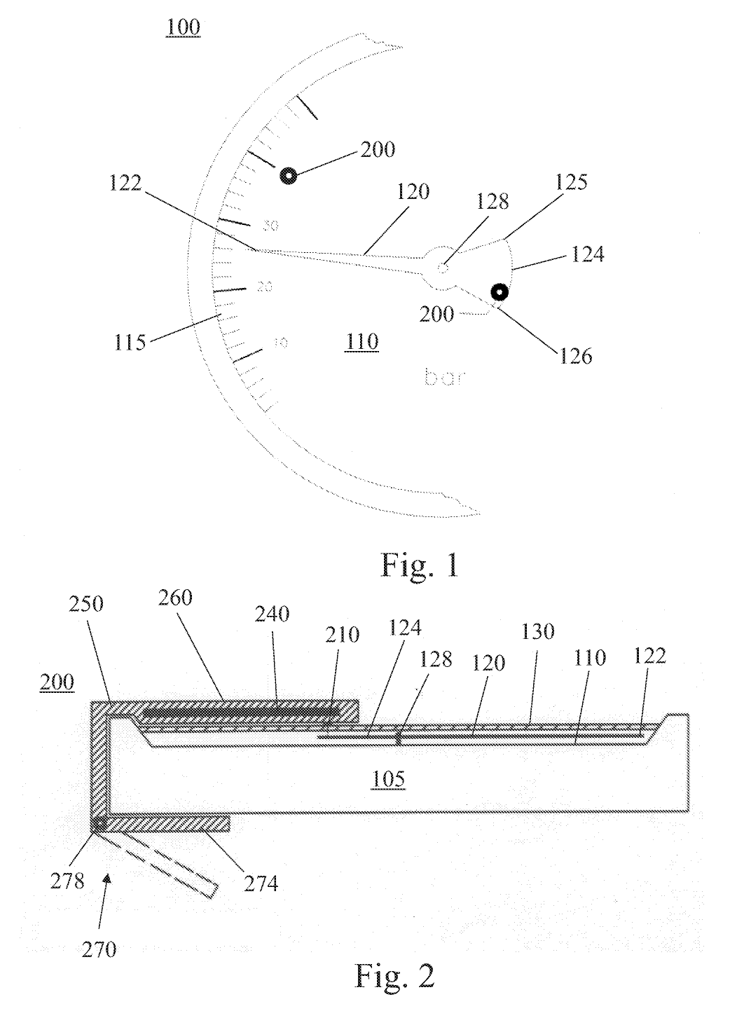

FIG. 2 shows a lateral sectional view of a monitoring unit in accordance with another exemplary embodiment of the present invention;

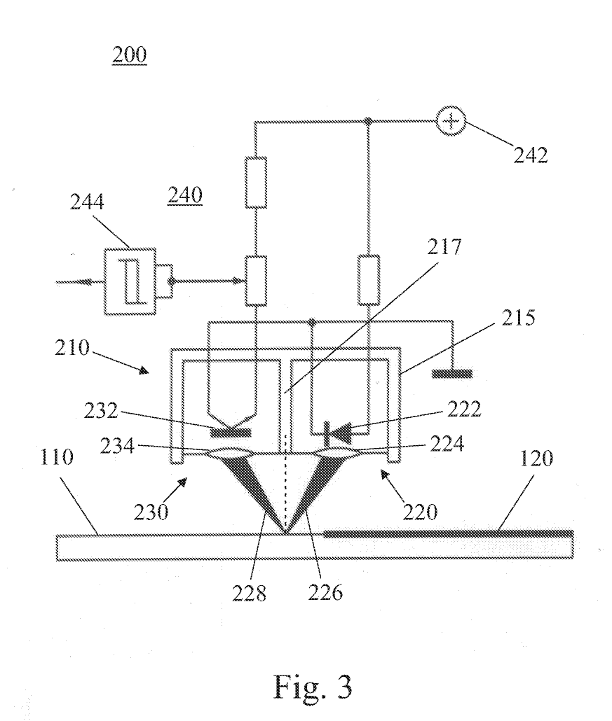

FIG. 3 shows a block diagram of a monitoring unit in accordance with one exemplary embodiment of the present invention;

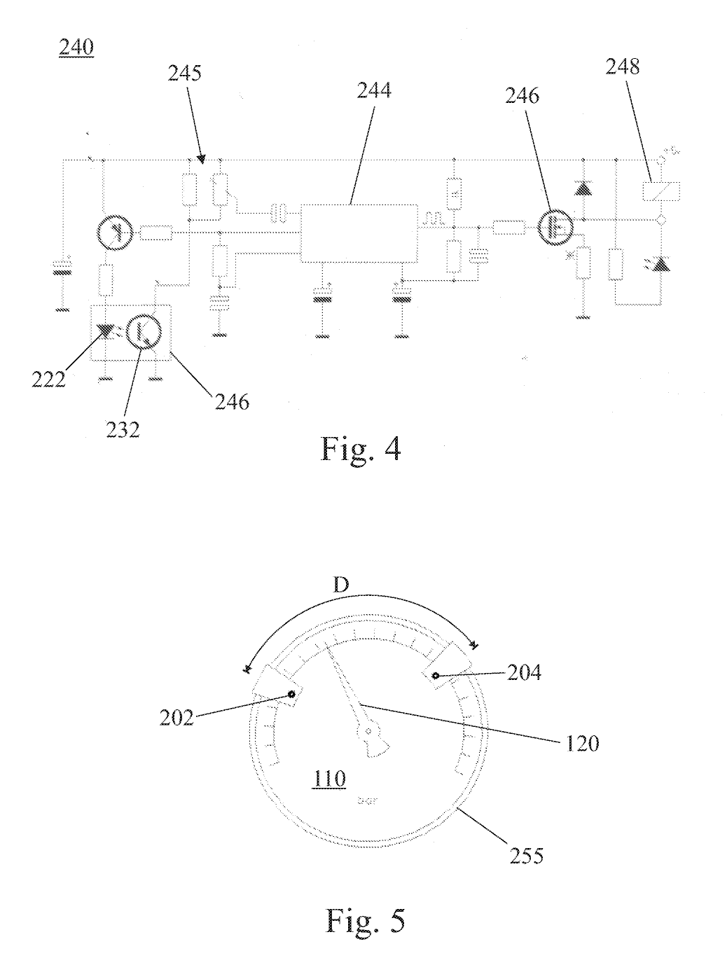

FIG. 4 shows a circuit for a monitoring unit in accordance with one exemplary embodiment of the present invention;

FIG. 5 shows a plan view of a further exemplary embodiment of the present invention;

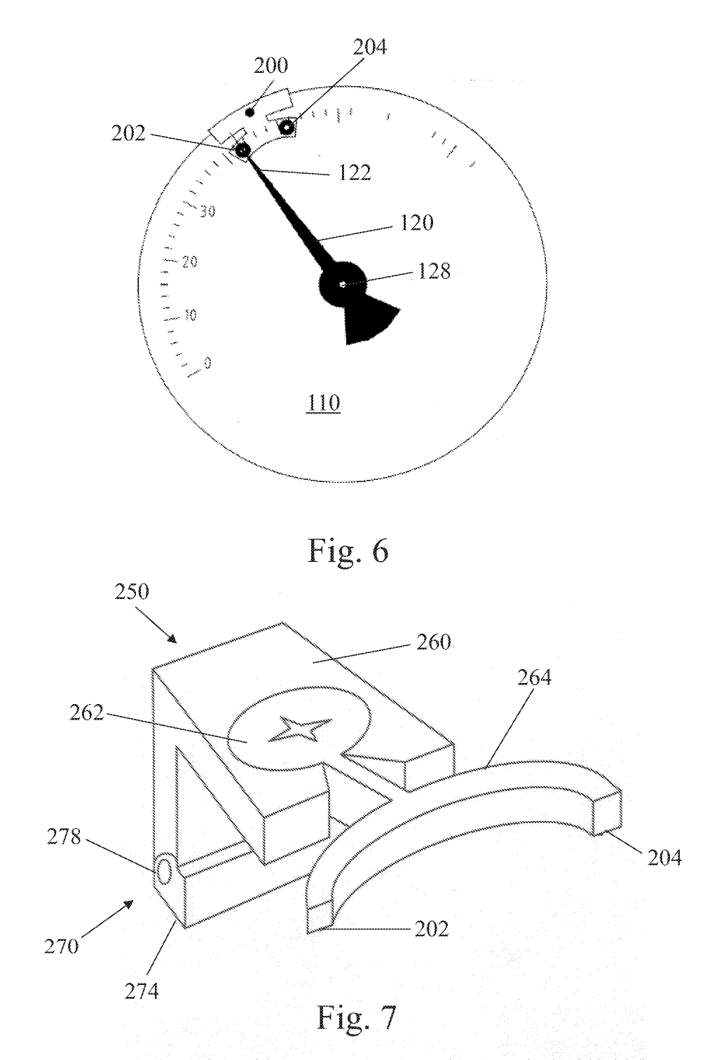

FIG. 6 shows a plan view of yet a further exemplary embodiment of the present invention;

FIG. 7 shows a perspective view of another exemplary embodiment of the present invention;

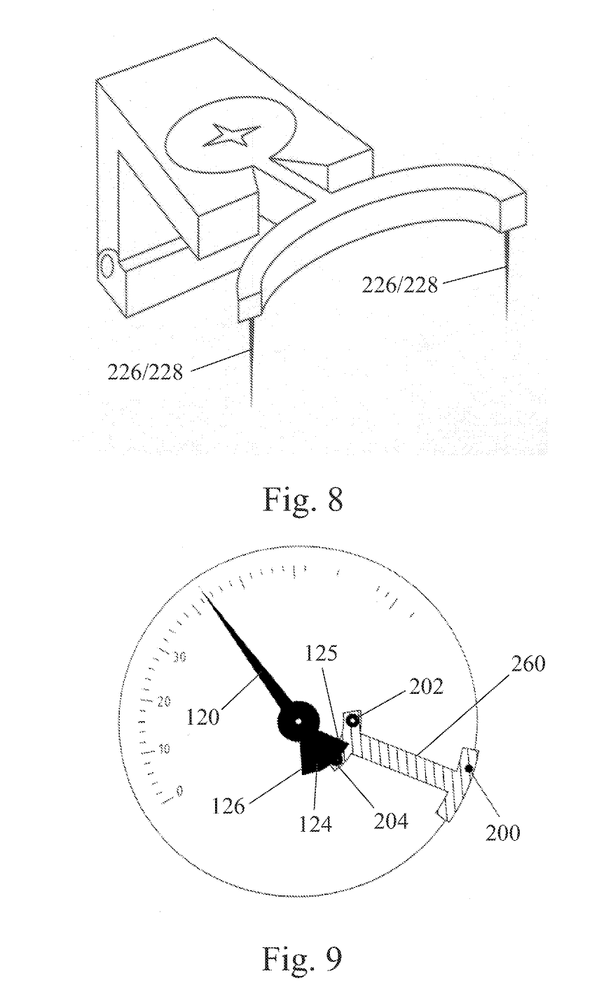

FIG. 8 shows a view of the exemplary embodiment from FIG. 7, in operation;

FIG. 9 shows a plan view of yet a further exemplary embodiment of the present invention;

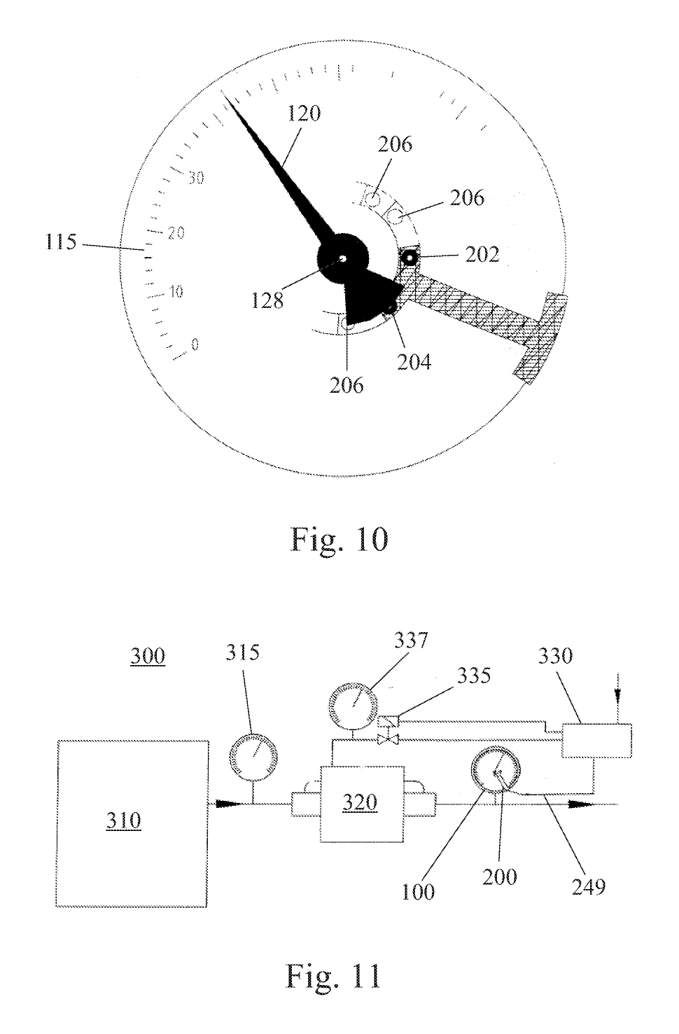

FIG. 10 shows a plan view of yet a further exemplary embodiment of the present invention;

FIG. 11 shows a schematic illustration of a pressure monitor with the aid of a monitoring unit in accordance with one exemplary embodiment of the present invention; and

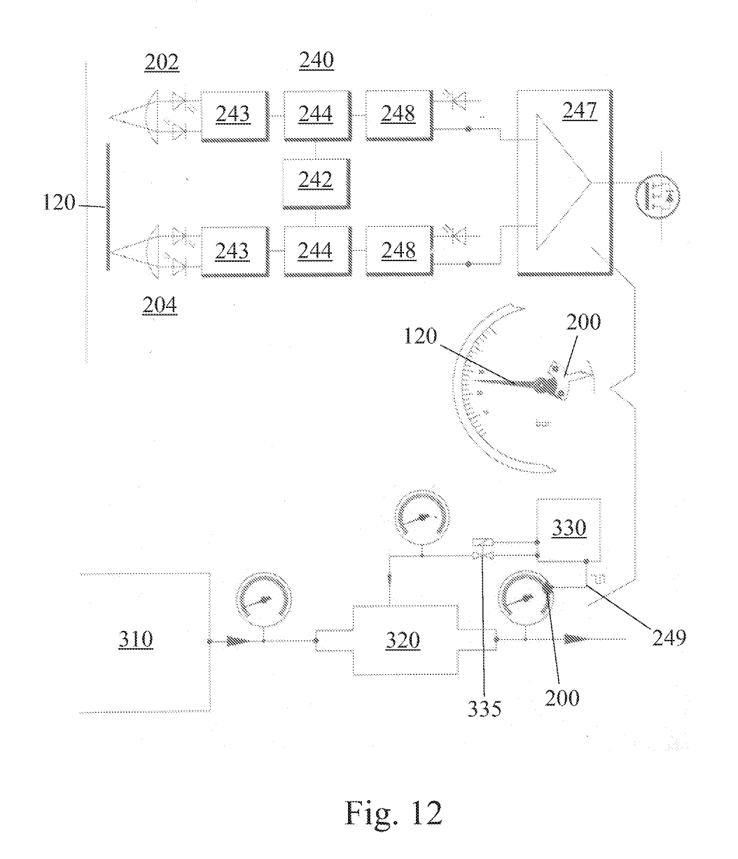

FIG. 12 shows a block diagram of the pressure monitor from FIG. 11.

FIG. 1 shows a top view of a measuring instrument 100 that has a pointer 120 that is arranged over a dial 110. A scale of measurement values 115 is fitted on the dial plate 110. The pointer 120 has a pointer tip 122 that is located in the area of the scale of measurement values 115. Furthermore, the pointer 120 has a pointer foot 124 that has a first lateral edge 125 and a second lateral edge 126. The pointer 120 is supported to be able to rotate about a rotation axis 128 so that the pointer tip 122 sweeps over the scale of measurement values 115 in a rotation of the pointer 120. Furthermore, by way of example FIG. 1 shows an arrangement of a monitoring unit 200 in accordance with one exemplary embodiment of the present invention. In a first example, in this case the monitoring unit 200 is arranged in the vicinity of the scale of measurement values 115 so that it can detect the pointer tip 122. In a second example, the monitoring unit 200 is arranged in the area of the pointer foot 124 so that it can detect the first lateral edge 125 and/or the second lateral edge 126 of the pointer foot.

FIG. 2 shows a lateral sectional view of a monitoring unit in accordance with one exemplary embodiment of the present invention. In this case, a measuring instrument to be monitored has a housing 105 of a display. One surface of the housing 105 has a cutout on the bottom of which the dial plate 110 is fitted. The pointer 120 is supported to be able to rotate above the dial plate about a rotation axis 128. In this case, the pointer 120 extends substantially parallel to the dial plate 110. The pointer 120 and the dial plate 110 are protected against external influences by a glass cover 130. The monitoring unit 200 has a detecting means 210 and a fastening means 250. In this case, the detecting means 210 is arranged in a carrier 260 of the fastening means. Furthermore, a circuit 240 for driving the detecting means 210 and for evaluating signals that are transmitted by the detecting means 210 to the circuit 240 is integrated in the carrier 260. The fastening means 250 further has a snap lock 270 in the case of which the pivoting arm 274 is supported to be able to pivot about a pivot axis 278. It is possible with the aid of the fastening means 250 to arrange the detecting means 210 above the display such that it can detect the pointer foot 124 of the pointer 120.

FIG. 3 shows a block diagram with the aid of which the mode of operation of the monitoring unit 200 will now be explained. The monitoring unit 200 has a detecting means 210 that is connected to a drive and evaluation circuit 240. The detecting means has a light source 220 and a sensor 230. The light source 220 and the sensor 230 are arranged laterally next to one another. In this arrangement, the light source 220 and the sensor 230 are integrated in a housing 215, but are separated from one another by a wall 217 so that the light 226 emitted by the light source cannot fall directly onto the sensor 230. The light source 220 comprises an IR photodiode 222 whose light is focused by means of a lens 224. A focus of 5-50 mm is typically set thereby. The light 226 focused in this way falls onto the surface of the dial plate 110 and is reflected thereby. The reflected light 228 is picked up by a lens 234 of the sensor 230 and directed onto a phototransistor 232. The phototransistor 232 generates an output signal in accordance with the received reflected light 228. In order for the sensor 230 to be able to pick up sufficiently well the light emitted by the light source 220, the emitted light 226 should strike the dial plate 110 at an angle differing from 90°. This can be attained either by alignment of the photodiode 222 or else by the alignment and/or the shape of the lens 224. The surface 110 of the dial plate is usually white in color, and so essentially all the emitted light 226 also reaches into the sensor area 230 as reflected light 228. If the pointer 120 now moves to the point at which the light 226 strikes, the emitted light 226 is now reflected by the pointer 120 instead of by the dial plate 110. The reflection behavior of the light is changed thereby, that is to say the reflected light 228 has a characteristic other than in the case in which the light has been reflected by the dial plate 110.

This change in the reflection characteristic is detected by the evaluation circuit 240. A Schmitt trigger 244 is typically used to detect the change in the reflection. The further details of the evaluation circuit 240 will be explained further below with reference to FIG. 4. The monitoring unit 200 further has a power supply unit 242 that either can be designed as a battery, or else can be provided via an external power pack. Supply via solar cells is also conceivable in principle. The power supply unit 242 supplies both the detecting means 210 and the evaluation circuit 240.

FIG. 4 shows a more accurate illustration of the evaluation circuit 240. The detection of the pointer position, and the triggering of the corresponding switching operation are implemented in this case with the aid of an IR diode and a phototransistor. A Schmitt trigger 244 is used in this case to detect the change in the reflection behavior. In this case, the IR diode 222 emits light, and the reflected or retroreflected modulated infrared light is picked up by the phototransistor 232. Together with the resistors 245, the phototransistor 232 forms a type of voltage divider that can be used to set the sensitivity, that is to say the required switching threshold, of the Schmitt trigger 244. If the Schmitt trigger 244 detects that the pointer 120 has overshot a prescribed maximum value, or has undershot a prescribed minimum value, a controller 248 is driven via the switching transistor 246. The controller 248 can be designed as a solenoid valve, for example, in the case of a pressure monitor.

FIG. 5 shows a monitoring unit in accordance with a further exemplary embodiment of the present invention. In this case, the monitoring unit 200 has a first detecting means 202 and a second detecting means 204. The first and the second detecting means 202, 204 are respectively fastened on a ring 255. The ring 255 can be fitted on the housing of the display unit of the measuring instrument, for example by means of screws, or else by means of a snap lock. The first and the second detecting means 202, 204 are connected to the ring 255 in a freely moveable fashion. It is possible in this way for the circumferential spacing D between the first and the second detecting means 202, 204 to be set variably. It is thereby possible to define in a simple way a measuring range in the case of which, for example, the first detecting means 202 defines a minimum value, and the second detecting means 204 defines a maximum value for the measured variable to be determined.

FIG. 6 shows a monitoring unit in accordance with yet a further exemplary embodiment of the present invention. In this case, a first detecting means 202 and a second detecting means 204 are arranged in the area of the pointer tip 122. By contrast with the exemplary embodiment shown in FIG. 5, however, the circumferential spacing between the first detecting means 202 and the second detecting means 204 is permanently prescribed here. In this way, the measuring range between the minimum value and the maximum value is set precisely and cannot be varied.

FIG. 7 shows a perspective view of the exemplary embodiment in accordance with FIG. 6. Here, a first detecting means 202 and a second detecting means 204 are integrated in a substantially T-shaped arm 264 of the fastening means 250. The substantially T-shaped arm 264 has a curve that is adapted to the circumference of the dial plate 110. The T-shaped arm 264 is connected to the carrier 260 of the fastening means 250 via a connecting means 262. The fastening means 250 also exhibits the snap mechanism 270 with pivoting arm 274 and articulation 278.

FIG. 8 shows the monitoring unit from FIG. 7, in operation. Here, the first and the second detecting means 202, 204 respectively transmit and receive light 226, 228 in order to detect the pointer position of the measuring instrument.

FIG. 9 shows a monitoring unit in accordance with yet another exemplary embodiment of the present invention. The design does not differ fundamentally from the exemplary embodiment shown in FIG. 6. However, the carrier 260 of the fastening means 250 is of long design in a radial direction, and so the first detecting means 202 and the second detecting means 204 are arranged in the area of the pointer foot 124. In this case, both the first and the second detecting means 202, 204 can respectively detect a first lateral edge 125 and a second lateral edge 126 of the pointer foot 124. Thus, for example, the second detecting means 204 can output a first signal when the second lateral edge 126 is detected, and a second signal when the first lateral edge 125 is detected. For example, it is possible in this way to implement a first warning stage upon detection of the second lateral edge 126, and a second warning stage, or a switch off, upon detection of the first lateral edge 125. It is also correspondingly possible to detect excessively low measured values with the aid of the first detecting means 202. One-stage or two-stage detection is also possible here, the first lateral edge 125 firstly being detected, and then the second lateral edge 126.

FIG. 10 shows yet a further exemplary embodiment of the present invention. This exemplary embodiment constitutes a development of the exemplary embodiment from FIG. 9. In this case, yet further detecting means 206 are provided in addition to the first and the second detecting means 202, 204. The detecting means 202, 204, 206 can be arranged in principle in the form of a ring around the rotation axis 128. In this way, the position of the pointer 120 can be detected in segments with regard to the scale of measurement values 115. The segments can have identical or various angular extents in this case.

FIG. 11 shows a block diagram of a pressure monitor 300. For example, the operation of an experimental rig in the laboratory requires a high pressure compressor 320 that is supplied with compressed air by a second compressor 310. It is impermissible to exceed the pressure for example 1000 bar, provided by the high pressure compressor 320 on the output side. In order to monitor this permissible maximum pressure of 1000 bar, an analog manometer 100 is connected to a pressure line. This analog manometer uses a pointer to display the pressure present on the pressure line. In accordance with one exemplary embodiment of the present invention, the manometer 100 is monitored by means of a monitoring unit 200. In this case, a control output of the monitoring unit 200 is connected to a controller 330 via a signal line 249. If the monitoring unit 200 determines an overshooting of the maximum permissible pressure value, it passes on a control signal to the controller 330 via the signal line 249. The controller 330 thereupon drives a solenoid valve 335. This now feeds only compressed air at the domestic pressure of 6 bar to the high pressure compressor 320, and so the pressure output by the high pressure compressor drops. A more reliable operation of the experimental rig is enabled in this way without always having to read off the manometer 100. The monitoring unit 200 designed as an adapter automatically determines the overshooting of the set maximum pressure via the optical sensor, and the compressed air feed is automatically interrupted. Such an automatic switch off has so far been possible only by exchanging the analog manometers for digital manometers, or by the expensive installation of forked light barriers, and is thus accompanied by high costs.

FIG. 12 shows a block diagram of the pressure monitor from FIG. 11. It is made clear here in the upper part of FIG. 12 how the monitoring unit 200 records the position of the pointer 120 by means of a first detecting means 202 and a second detecting means 204. Both the first detecting means 202 and the second detecting means 204 are supplied via a common power supply unit 242. Measured signals from the first and second detecting means 202, 204 are transmitted via respective preamplifiers 243 to respective Schmitt triggers 244 in order to detect the reflection state. The first and second detecting means 202, 204 are connected up to a comparator 247 via respective switching outputs 248. If the comparator 247 determines that the set maximum value has been overshot, a control signal is transmitted to the controller 330 via the signal line 249. The controller 330 uses this pressure signal to drive a solenoid valve 335 in order thus to reduce the compressed air feed to the high pressure compressor 320.

The monitoring unit in accordance with the above described exemplary embodiments of the present invention is capable of universal use and enables electronic further processing of measured values taken in analog fashion. The adapter is portable and can easily be set up on all common measuring instruments, in particular manometers. In the case of the monitoring unit in accordance with the exemplary embodiments of the present invention, the sensor may be fastened, with the inclusion of the electronics, on the housing of the measuring instrument, and is therefore compatible with most measuring instruments. The monitoring unit can easily be taken off again and used on measuring instruments already installed, without there being any need to intervene in the process cycle by modification.

The monitoring unit in accordance with the exemplary embodiments of the present invention can be used, or set up for, measuring instruments, in particular manometers, of different pressure stages, as a universal controller that has a pressure range which can be set and is easy to mount. The monitoring unit in accordance with the exemplary embodiments of the present invention permits optoelectrical monitoring and setting of desired measured value ranges, in particular pressure ranges, with virtually unlimited setting ranges and life cycle. The monitoring unit in accordance with the exemplary embodiments of the present invention has explosion-protected control that can be supplied with minimum voltage externally thanks to microprocessor technology. The setting of the measuring ranges is considerably performed simply by manual setting, but can also be done by remote control.

The present invention has been explained with the aid of exemplary embodiments. These exemplary embodiments should in no way be understood as imposing restrictions on the present invention. In particular, the present invention can also be implemented with geometry and/or materials other than the ones described above.

### LIST OF REFERENCE SYMBOLS

100 Measuring instrument
110 Dial plate
115 Scale of measurement values
120 Pointer
122 Pointer tip
124 Pointer foot
125 First lateral edge
126 Second lateral edge
128 Rotation axis
130 Glass cover
200 Monitoring unit
202 First detecting means
204 Second detecting means
206 Further detecting means
210 Detecting means
215 Housing
217 Partition
220 Light source
222 Photodiode
224 Lens
226 Emitted light
228 Reflected light
230 Sensor
232 Phototransistor
234 Lens
240 Circuit
242 Voltage source
244 Schmitt trigger
246 Switching transistor
247 Comparator
248 Controller
249 Signal line
250 Fastening means
255 Ring
260 Carrier
262 Connecting means
264 T-shaped arm
270 Snap lock
274 Pivoting arm
278 Pivot axis
300 Pressure monitor
310 Auxiliary compressor
320 High pressure compressor
330 Controller
335 Solenoid valve
D Circumferential spacing

1. A monitoring unit for a measuring instrument (100) with a pointer (120) and a face (110), pointer (120) and face (110) having mutually differing reflection behaviors for light, comprising
at least one first detecting means (210) with a light source (220) and a first sensor (230), and
at least one fastening means (250) for fastening the detecting means (210) on the measuring instrument (100),
characterized in that
the detecting means (210) can be arranged with the aid of the fastening means (250) such that the first sensor (230) can pick up light (228) reflected by the measuring instrument (100) that was emitted by the first light source (220).

2. The monitoring unit as claimed in claim 1, in which the first light source (220) and the first sensor (230) are arranged laterally next to one another.

3. The monitoring unit as claimed in claim 1, in which the detecting means (210) comprises a lens (224; 234) for focusing the light.

4. The monitoring unit as claimed in claim 3, in which the fastening means (210) comprises a common lens for the first light source (220) and the first sensor (230).

5. The monitoring unit as claimed in claim 1, in which the first light source (220) is a photodiode (222).

6. The monitoring unit as claimed in claim 5, in which the first light source (220) is an IR photodiode (222).

7. The monitoring unit as claimed in claim 1, in which the first sensor (230) is a phototransistor (232).

8. The monitoring unit as claimed in claim 1, in which the light source (220) and the sensor (230) are integrated in a housing (215).

9. The monitoring unit as claimed in claim 1, in which the monitoring unit is designed such that it is capable when operating of detecting the position of a pointer tip (122) of the pointer (120).

10. The monitoring unit as claimed in claim 1, in which the monitoring unit is designed such that it is capable when operating of detecting the position of a pointer foot (124) of the pointer (120).

11. The monitoring unit as claimed in claim 1, in which the fastening means (250) is designed to be capable of fastening on a housing of the measuring instrument (100).

12. The monitoring unit as claimed in claim 11, in which the fastening means (250) comprises a ring that can be fastened on the housing.

13. The monitoring unit as claimed in claim 12, in which the ring is designed such that a number of fastening means (210) can be fastened on it.

14. The monitoring unit as claimed in claim 1, in which the fastening means (250) comprises a snap lock (270).

15. The monitoring unit as claimed in claim 1, in which the fastening means (250) is formed at least partially from a transparent material.

16. The monitoring unit as claimed in claim 15, in which the transparent material is Perspex.

17. The monitoring unit as claimed in claim 1, in which the detecting means (210) is designed in a fashion integrated with the fastening means (250).

18. The monitoring unit as claimed in claim 1, further comprising a circuit (240) for driving the detecting means (210) and/or for signal processing of signals from the detecting means (210), and/or for evaluating signals from the detecting means (210).

19. The monitoring unit as claimed in claim 1, in which the circuit (240) is designed in a fashion integrated with the fastening means (250).

20. The monitoring unit as claimed in claim 18, in which the responsiveness of the circuit (240) can be set.

21. The monitoring unit as claimed in claim 1, further comprising a second detecting means (204).

22. The monitoring unit as claimed in claim 21, in which the spacing between the first and second detecting means (202, 204) is permanently prescribed by the fastening means (250).

23. The monitoring unit as claimed in claim 21, in which the spacing between the first and second detecting means (202, 204) is variable.

24. The monitoring unit as claimed in claim 1, further comprising a connection for a controller (330).

25. The monitoring unit as claimed in claim 1, in which the measuring instrument (100) is a manometer.

26. The monitoring unit as claimed in claim 25, in which the monitoring unit (200) is connected to a pressure controller (330).
